(19) United States
(12) Patent Application Publication
(10) Pub. No.: US 2025/0137236 A1
(43) Pub. Date: May 1, 2025

(54) SHOVEL, DISPLAY DEVICE, AND SHOVEL CONTROL SYSTEM

(71) Applicant: SUMITOMO CONSTRUCTION MACHINERY CO., LTD., Tokyo (JP)

(72) Inventors: Yuiki MATSUHASHI, Chiba (JP); Nobutada SAKATA, Chiba (JP)

(21) Appl. No.: 18/922,847

(22) Filed: Oct. 22, 2024

(30) Foreign Application Priority Data
Oct. 31, 2023 (JP) 2023-187090

(51) Int. Cl. E02F 9/26; E02F 3/32; E02F 9/22; G06T 11/00; G06V 20/58; G06V 40/10

(52) U.S. Cl. CPC E02F 9/261; G06T 11/00; G06V 20/58; G06V 40/10; E02F 3/32; E02F 9/2228; E02F 9/2285; E02F 9/2292; E02F 9/2296

(57) ABSTRACT

A shovel includes a lower traveling body, an upper swivel body swiveling with respect to the lower traveling body, an object detection device to detect an object around the shovel, an angle detection device to detect a swivel angle of the upper swivel body with respect to the lower traveling body, a control device to acquire the swivel angle and positional information about a person around the shovel, and a display device simultaneously to display first display information and second display information in a predetermined display area in a manner that represents a positional relation between the shovel and the person, the first display information representing the shovel based on the swivel angle in such a manner that the angle between the upper swivel body and the lower traveling body can be recognized, and the second display information representing the person at a position indicated by the positional information.

### RELATED APPLICATION

Priority is claimed to Japanese Patent Application No. 2023-187090, filed Oct. 31, 2023, the entire content of which is incorporated herein by reference.

### BACKGROUND

### Technical Field

The disclosures herein relate to shovels, display devices, and shovel control systems.

### Description of Related Art

There has been proposed a technology to display a surrounding situation when operations are performed with a shovel. For example, there is a technology to display an icon representing the shovel and a direction in which the shovel travels on a shovel display device.

### SUMMARY OF THE INVENTION

A shovel includes a lower traveling body, an upper swivel body capable of swiveling with respect to the lower traveling body, an object detection device provided on the upper swivel body and configured to detect an object existing around the shovel, an angle detection device configured to detect a swivel angle of the upper swivel body with respect to the lower traveling body, a control device configured to acquire the swivel angle and positional information about a person existing around the shovel from a detection result of the object detection device, and a display device configured simultaneously to display first display information and second display information in a predetermined display area in a manner that represents a positional relation between the shovel and the person, the first display information representing the shovel based on the swivel angle in such a manner that the angle between the upper swivel body and the lower traveling body can be recognized, and the second display information representing the person existing at a position indicated by the positional information.

### BRIEF DESCRIPTION OF THE DRAWINGS

FIG. 1 is a side view of a shovel according to one embodiment;

FIG. 2 is a top view of the shovel according to one embodiment;

FIG. 3 is a drawing illustrating an example of a configuration of a basic system mounted on the shovel according to one embodiment;

FIG. 4 is a drawing illustrating an example of a display screen displayed by a display device according to one embodiment;

FIG. 5 is a drawing illustrating changes in a shovel icon and a direction display icon displayed on an image display part according to one embodiment;

FIG. 6A is a drawing illustrating changes in a display mode of a shovel state display area when there is no person in a front area, as displayed by the display device according to modification 1 of one embodiment;

FIG. 6B is a drawing illustrating changes in a display mode of a shovel state display area when there is a person in a front area, as displayed by the display device according to modification 1 of one embodiment;

FIG. 7 is a flowchart illustrating a processing procedure for displaying the display screen by a controller and the display device according to modification 1 of one embodiment;

FIG. 8 is a drawing illustrating an example of the display screen displayed by the display device according to modification 2 of one embodiment;

FIG. 9 is a drawing illustrating an example of the display screen displayed by the display device according to modification 3 of one embodiment; and

FIG. 10 is a schematic view illustrating an example of a configuration of a remote support system of the shovel according to another embodiment.

### DETAILED DESCRIPTION

However, although a direction in which a shovel travels can be recognized by the related art, it is difficult to grasp a positional relation between the shovel and a person existing around the shovel.

One embodiment of the present invention displays the positional relation between the shovel and the person together with the direction in which the shovel travels so as to grasp the surrounding situation and to improve safety.

According to an embodiment of the present invention, safety can be improved by grasping the surrounding situation.

In the following, embodiments of the present invention will be described with reference to the accompanying drawings. The embodiments described below are not intended to limit the invention, but are merely examples, and not all the features and combinations thereof described in the embodiments are necessarily essential to the invention. The same or corresponding components in the respective drawings are denoted by the same or corresponding reference numerals, and the description thereof may be omitted.

In the embodiments of the present invention, an example using a shovel as an example of a working machine will be described below, but the invention is not limited to a shovel. It may be applied to such as any construction machine, a standard machine, an advanced machine, a forestry machine, or a conveyance machine based on a hydraulic shovel.

### Embodiment One

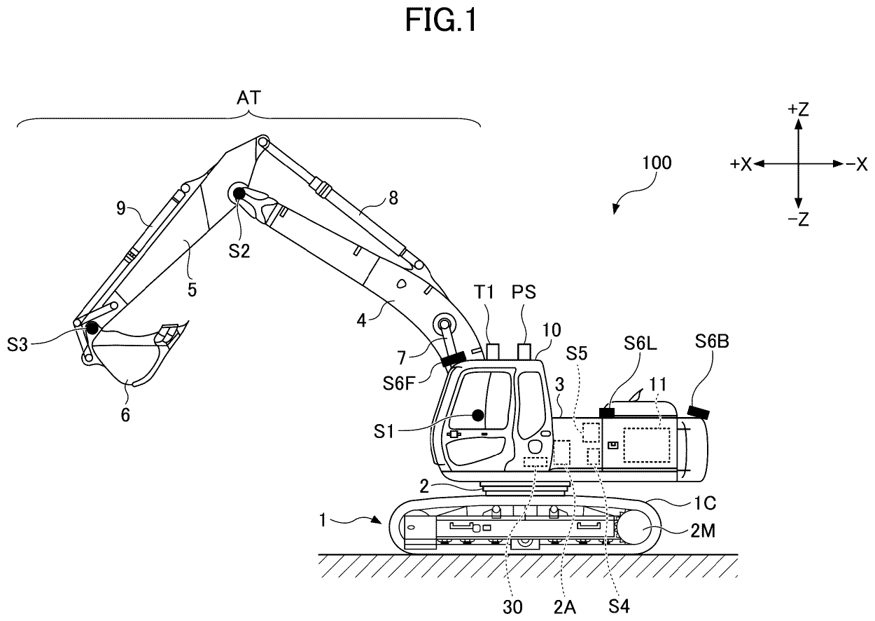

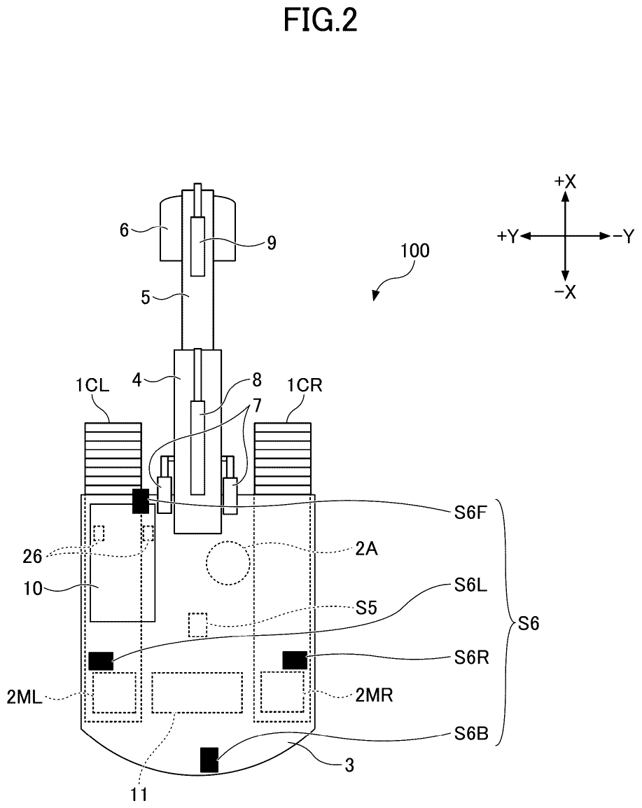

First, a summary of a shovel 100 according to the present embodiment will be described with reference to FIGS. 1 and 2. FIGS. 1 and 2 are a top view and a side view, respectively, of the shovel 100 according to the present embodiment.

As shown in FIGS. 1 and 2, the shovel 100 according to the present embodiment includes a lower traveling body 1, an upper swivel body 3 mounted on the lower traveling body 1 so as to be able to swivel via a swivel mechanism 2, an attachment AT for performing various operations, and a cabin 10. Hereinafter, a front of the shovel 100 (upper swivel body 3) corresponds to a direction in which the attachment to the upper swivel body 3 extends when the shovel 100 is viewed in a planar view (top view) from directly above along the swivel axis of the upper swivel body 3. A left direction and a right direction of the shovel 100 (upper swivel body 3) correspond to the left direction and the right direction, respectively, as viewed from an operator seated on an operator's seat in the cabin 10.

The lower traveling body 1 includes, for example, a pair of left and right crawlers 1C. More specifically, the crawler 1C includes a left crawler 1CL and a right crawler 1CR. The lower traveling body 1 causes the shovel 100 to travel by the left crawler 1CL and the right crawler 1CR being hydraulically driven by the left hydraulic motor 2ML and the right hydraulic motor 2MR, respectively.

The upper swivel body 3 rotates with respect to the lower traveling body 1 by the swivel mechanism 2 being hydraulically driven by the swivel hydraulic motor 2A. That is, the swivel hydraulic motor 2A is a swivel drive that drives the upper swivel body 3 as a driven part, and can change the direction of the upper swivel body 3.

The attachment AT (an example of an attachment) includes a boom 4, an arm 5, and a bucket 6.

The boom 4 is mounted to the front center of the upper swivel body 3 so as to be able to be elevated, the arm 5 is mounted to the tip of the boom 4 so as to be vertically rotatable, and the bucket 6 is mounted to a tip of the arm 5 so as to be vertically rotatable.

The bucket 6 is an example of a working tool. The bucket 6 is used, for example, for excavation work. Another working tool may be mounted to the tip of the arm 5 in place of the bucket 6 according to the contents of the work. The other working tool may be another type of bucket, for example, a large bucket, a slope bucket, a dredging bucket, etc. The other working tool may be a type of working tool other than a bucket such as an agitator, a breaker, or a grapple.

The boom 4, the arm 5, and the bucket 6 are hydraulically driven by the boom cylinder 7, the arm cylinder 8, and the bucket cylinder 9 as hydraulic actuators, respectively, using hydraulic fluid discharged from the main pump 14 (described later).

The shovel 100 may be configured such that a part of the driven elements such as the lower traveling body 1, the upper swivel body 3, the boom 4, the arm 5, and the bucket 6 are electrically driven. That is, the shovel 100 may be a hybrid shovel, an electric shovel, or the like, in which a part of the driven elements is driven by an electric actuator.

An imaging device S6 is an example of an object detection device, and is provided on the upper swivel body 3, and detects an object around the shovel 100, and outputs the detection result to the controller 30.

The imaging device S6 is provided on the upper swivel body 3, and captures images of objects around the shovel 100, and outputs image information representing the object around the shovel 100 to the controller 30. The imaging device S6 includes a camera S6F to capture images of the front of the shovel 100, a camera S6L to capture images of the left direction of the shovel 100, a camera S6R to capture images of the right direction of the shovel 100, and a camera S6B to capture images of a rear of the shovel 100.

The camera S6F is mounted outside the cabin 10, such as on a roof of the cabin 10 and on a side of the boom 4. The camera S6F may be mounted, for example, on a ceiling of the cabin 10, that is, inside the cabin 10. The camera S6L is mounted on the left end of the upper surface of the upper swivel body 3, the camera S6R is mounted on the right end of the upper surface of the upper swivel body 3, and the camera S6B is mounted on the rear end of the upper surface of the upper swivel body 3.

Each of the imaging devices S6 (cameras S6F, S6B, S6L, S6R) is, for example, a monocular wide-angle camera having a very wide angle of view. The imaging device S6 has, for example, an image sensor such as a CCD or CMOS, and outputs a captured image to the display device 40. Furthermore, the image information captured by the imaging device S6 is also received by the controller 30.

The imaging device S6 according to the present embodiment shows an example of an object detection device, and any apparatus capable of detecting an object may be used.

As the object detection device, LIDAR may be used to detect an object existing around the shovel 100. LIDAR measures, for example, distances between one million or more points within a monitoring range and the LIDAR measuring device. The present embodiment is not limited to a method using LIDAR, but any object detection device capable of measuring a distance to the object may be used. For example, a stereo camera may be included, and a distance measuring device such as a distance image camera or a millimeter wave radar may be used. When the millimeter wave radar or the like is used as the object detection device, the distance and direction of the object may be derived from the reflected signals by transmitting a large number of signals (laser beams or the like) from the object detection device toward the object and receiving reflected signals.

Further, two or more types of devices may be combined as the object detection device. For example, an imaging device and LIDAR may be combined, an imaging device and a millimeter wave radar may be combined, and an imaging device and a stereo camera may be combined.

The controller 30 is a controller to control the shovel 100. For example, the controller 30 includes a computer including a central processing unit (CPU), a read only memory (ROM), a random access memory (RAM), a non-volatile auxiliary storage medium, and various input and output interfaces. The controller 30 reads programs from the non-volatile storage medium, loads them into a volatile storage medium, and causes the CPU to execute them, thereby achieving various functions. The various functions include, for example, a machine guidance function to guide a manual operation of the shovel 100 by the operator. The controller 30 may include a contact avoidance function to automatically or autonomously operate or stop the shovel 100 in order to avoid contact between the shovel 100 and objects present in the monitoring range around the shovel 100.

For example, the controller 30 sets a target rotation speed based on the operation of the operator or the like, and performs drive control to rotate an engine 11 at a constant speed.

The boom angle sensor S1 is attached to the boom 4 and detects an elevation angle (hereinafter referred to as “boom angle”) of the boom 4 with respect to the upper swivel body 3, for example, an angle formed by a straight line connecting fulcrums at both ends of the boom 4 with respect to the swivel plane of the upper swivel body 3 in a side view. The boom angle sensor S1 may include, for example, a rotary encoder, an acceleration sensor, a six-axis sensor, an IMU (Inertial Measurement Unit), and the like. The boom angle sensor S1 may also include a potentiometer using a variable resistor, a cylinder stroke sensor to detect the stroke amount of the hydraulic cylinder (boom cylinder 7) corresponding to the boom angle, and the like. Hereinafter, the same applies to the arm angle sensor S2 and the bucket angle sensor S3. The detection signal corresponding to the boom angle by the boom angle sensor S1 is received by the controller 30.

The arm angle sensor S2 is attached to the arm 5 and detects a rotation angle (hereinafter referred to as “arm angle”) of the arm 5 with respect to the boom 4, for example, the angle formed by the straight line connecting the fulcrums at both ends of the arm 5 with respect to the straight line connecting the fulcrums at both ends of the boom 4 in the side view. The detection signal corresponding to the arm angle by the arm angle sensor S2 is received by the controller 30.

The bucket angle sensor S3 is attached to the bucket 6 and detects the rotation angle (hereinafter referred to as “bucket angle”) of the bucket 6 with respect to the arm 5, for example, the angle formed by the straight line connecting the fulcrum and the tip (toe) of the bucket 6 with respect to the straight line connecting the fulcrums at both ends of the arm 5 in the side view. The detection signal corresponding to the bucket angle by the bucket angle sensor S3 is received by the controller 30.

The machine body tilt sensor S4 detects a tilt state of the machine body (upper swivel body 3 or lower traveling body 1) with respect to a horizontal plane. The machine body tilt sensor S4 is attached to the upper swivel body 3, for example, and detects a tilt angle of the shovel 100 (that is, the upper swivel body 3) around two axes in a longitudinal direction and a lateral direction (hereinafter, referred to as “longitudinal tilt angle” and “lateral tilt angle”, respectively). The machine body tilt sensor S4 may include, for example, a rotary encoder, an acceleration sensor, a six-axis sensor, an IMU, and the like. A detection signal corresponding to the tilt angle (longitudinal tilt angle and lateral tilt angle) by the machine body tilt sensor S4 is received by the controller 30.

The swivel angle sensor S5 (an example of an angle detection device) outputs detection information related to the swivel state of the upper swivel body 3 with respect to the lower traveling body 1. The swivel angle sensor S5 detects, for example, the swivel angle of the upper swivel body 3 with respect to the lower traveling body 1. Further, the swivel angle sensor S5 may detect the swivel angular velocity of the upper swivel body 3 with respect to the lower traveling body 1. The swivel angle sensor S5 may include, for example, a gyro sensor, a resolver, a rotary encoder, or the like. Detection signals corresponding to the swivel angle and the swivel angular velocity of the upper swivel body 3 by the swivel angle sensor S5 are received by the controller 30.

A positioning device PS measures the position and the direction of the upper swivel body 3. The positioning device PS is, for example, a GNSS (Global Navigation Satellite System) compass, and detects the position and the direction of the upper swivel body 3, and detection signals corresponding to the position and the direction of the upper swivel body 3 are received by the controller 30. Among the functions of the positioning device PS, the function of detecting the direction of the upper swivel body 3 may be replaced by an orientation sensor attached to the upper swivel body 3.

The cabin 10 is a control cabin in which an operator rides, and is mounted on the front left of the upper swivel body 3.

The cabin 10 may be omitted when the shovel 100 is operated by remote control or by fully automatic operation.

A communication device T1 communicates with external devices through a predetermined network including a mobile communication network, a satellite communication network, an Internet network, and the like having a base station as a terminal. The communication device T1 is, for example, a mobile communication module corresponding to mobile communication standards such as LTE (Long Term Evolution), 4G (4th Generation), and 5G (5th Generation), or a satellite communication module for connection to the satellite communication network.

The shovel 100 drives an actuator (e.g., hydraulic actuator) in response to the operation by the operator in the cabin 10 to drive operating elements (hereinafter, “driven element”) such as the lower traveling body 1, the upper swivel body 3, the boom 4, the arm 5, and the bucket 6.

Further, instead of or in addition to being operable by the operator in the cabin 10, the shovel 100 may be remotely operated from outside the shovel 100. When the shovel 100 is remotely operated, an interior of the cabin 10 may be unattended.

The shovel 100 may automatically operate the actuator regardless of the operation of the operator. Thus, the shovel 100 achieves a function of automatically operating at least a part of the driven elements such as the lower traveling body 1, the upper swivel body 3, the boom 4, the arm 5, and the bucket 6, that is, what is called an “automatic operation function” or a “machine control function”.

The automatic driving function may include a function for automatically operating driven elements (actuator) other than the driven element (actuator) to be operated in response to an operation or remote operation of an operating device 26 by the operator, that is, what is called a “semi-automatic operation function” or an “operation-assisted machine control function”. The automatic driving function may include a function for automatically operating at least a part of the plurality of driven elements (hydraulic actuators) on an assumption that there is no operation or remote operation of the operating device 26 by the operator, that is, what is called a “fully automatic operation function” or a “fully automatic machine control function”. When the fully automatic operation function is effective in the shovel 100, the interior of the cabin 10 may be unattended. The semi-automatic operation function, the fully automatic operation function, and the like may include a mode in which the operation content of the driven element (actuator) to be operated in accordance with a predetermined rule is automatically determined. The semi-automatic operation function, the fully automatic operation function, and the like may include a mode in which the shovel 100 autonomously makes various judgments and autonomously determines the operation content of the driven element (hydraulic actuator) to be operated in accordance with the judgment result (what is called an “automatic operation function”).

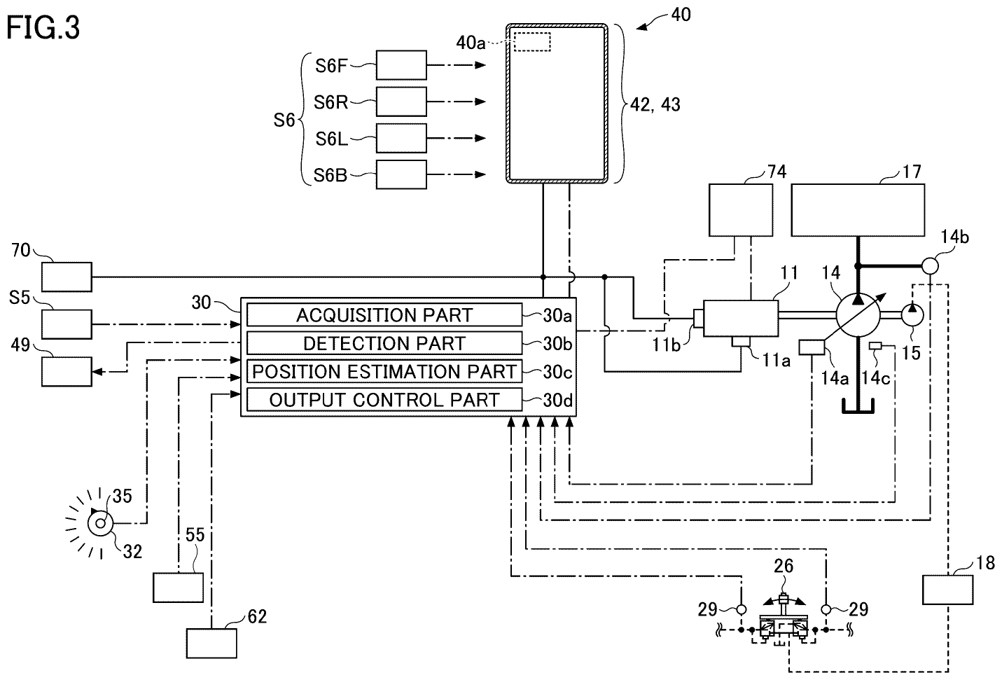

Next, a basic system mounted on the shovel 100 will be described with reference to FIG. 3. FIG. 3 is a drawing illustrating an example of a configuration of the basic system mounted on the shovel 100 according to the present embodiment. In FIG. 3, mechanical power transmission lines are represented by double lines, hydraulic fluid lines by thick solid lines, pilot lines by dashed lines, power line by thin solid lines, and electric control lines by dash-dotted lines.

The basic system has a controller 30 and an ECU (engine control unit) 74. The basic system has an engine 11, a main pump 14, a pilot pump 15, a control valve unit 17, and a selector valve 18 as control objects. The basic system has an operating device 26, an operation pressure sensor 29, a dial 32, a switch 35, a gate lock lever 55, and a key sensor 62 as input parts. The basic system has an alarm device 49 as output parts. The basic system has a display device 40 as a display part. The display device 40 serves as both an input part and an output part.

The engine 11 is a diesel engine adopting isochronous control to keep the engine rotation speed constant regardless of increase or decrease in load. Fuel injection quantity, fuel injection timing, boost pressure and the like in the engine 11 are controlled by the ECU 74.

The engine 11 is connected to the main pump 14 and the pilot pump 15 as hydraulic pumps, respectively. The main pump 14 is connected to the control valve unit 17 via the hydraulic fluid line.

The control valve unit 17 is a hydraulic control device to control the hydraulic system of the shovel 100. The control valve unit 17 is connected to hydraulic actuators such as a left traveling hydraulic motor, a right traveling hydraulic motor, a boom cylinder 7, an arm cylinder 8, a bucket cylinder 9, and a swivel hydraulic motor.

The control valve unit 17 includes a plurality of spool valves corresponding to the respective hydraulic actuators. The respective spool valves are configured to be displaceable according to the pilot pressure so that an opening area of a PC port and the opening area of a CT port can be increased or decreased. The PC port is a port for communicating the main pump 14 with the hydraulic actuator. The CT port is a port for communicating the hydraulic actuator with the hydraulic fluid tank.

The pilot pump 15 is connected to the operating device 26 via the pilot line. The operating device 26 includes, for example, a left operating lever, a right operating lever, and a travel operating device. The travel operating device includes, for example, a left running pedal, a right running pedal, a left running lever, and a right running lever. Each of the operating devices 26 is a hydraulic operating device and is connected via the pilot line to the pilot port of a corresponding spool valve in the control valve unit 17. However, the operating device 26 may be an electric operating device.

The pilot pump 15 may be omitted. In this case, the functions performed by the pilot pump 15 may be performed by the main pump 14. In addition to the function of supplying hydraulic fluid to the control valve unit 17, the main pump 14 may also have a function of supplying hydraulic fluid to the operating device 26 or the like after the pressure of the hydraulic fluid is lowered by a throttle or the like.

The operation pressure sensor 29 detects the operation of the operating device 26 in the form of pressure. The operation pressure sensor 29 outputs a detection value to the controller 30. However, the operation of the operating device 26 may be electrically detected.

The selector valve 18 is configured to switch between an enabled state and a disabled state of the operating device 26. The enabled state of the operating device 26 is a state in which the operator can operate the hydraulic actuator using the operating device 26. The disabled state of the operating device 26 is a state in which the operator cannot operate the hydraulic actuator using the operating device 26. The selector valve 18 is a gate lock valve configured to operate in response to a command from the controller 30. The selector valve 18 is arranged in the pilot line connecting the pilot pump 15 and the operating device 26, and is configured to switch isolation and communication of the pilot line in response to a command from the controller 30. The operating device 26 is enabled when, for example, the gate lock lever 55 is pulled up and the selector valve 18 (gate lock valve) is opened, and is disabled when the gate lock lever 55 is pushed down and the selector valve 18 (gate lock valve) is closed.

A storage battery 70 is charged by, for example, electricity generated by an alternator 11a. The electric power of the storage battery 70 is also supplied to the controller 30 and the like. For example, a starter 11b of the engine 11 is driven by the electric power from the storage battery 70 to start the engine 11.

The ECU 74 transmits data on the state of the engine 11 such as a cooling water temperature to the controller 30. A regulator 14a of the main pump 14 transmits data on a swash plate tilt angle to the controller 30. A discharge pressure sensor 14b transmits data on the discharge pressure of the main pump 14 to the controller 30. A fluid temperature sensor 14c provided in a conduit between the hydraulic fluid tank and the main pump 14 transmits data related to a temperature of hydraulic fluid flowing in the conduit to the controller 30. The operation pressure sensor 29 transmits data related to the pilot pressure generated when the operating device 26 is operated to the controller 30. The controller 30 can store these data in a temporary storage part (memory) and transmit them to the display device 40 when necessary.

The alarm device 49 is a device to call an attention of a person engaged in the operation of the shovel 100. The alarm device 49 includes, for example, a combination of an indoor alarm device and an outdoor alarm device. The indoor alarm device is a device to call the attention of the operator of the shovel 100 in the cabin 10, and includes, for example, at least one of a sound output device, a vibration generating device, and a light emitting device provided in the cabin 10. The indoor alarm device may be the display device 40. The outdoor alarm device is a device for calling the attention of the operator working around the shovel 100, and includes, for example, at least one of the sound output device and the light emitting device provided outside the cabin 10. The sound output device as the outdoor alarm device includes, for example, a travel alarm device attached to a bottom surface of the upper swivel body 3. The outdoor alarm device may be the light emitting device provided on the upper swivel body 3. However, the outdoor alarm device may be omitted. The alarm device 49 may, for example, notify a person engaged in the operation of the shovel 100 when the imaging device S6 functioning as the object detection device detects a predetermined object.

The key sensor 62 detects an electronic key of the shovel 100. The key sensor 62 detects an electronic key existing near the key sensor 62. The key sensor 62 can detect an electronic key existing in the cabin 10, for example. The key sensor 62 outputs a signal indicating detection of the electronic key to the controller 30. The key sensor 62 can detect an electronic key using wireless short-range communication such as Bluetooth (registered trademark).

The display device 40 displays various kinds of information. The display device 40 may be connected to the controller 30 via a communication network such as CAN or may be connected to the controller 30 via a leased line. The display device 40 can display one or more pieces of image information captured by the imaging device included in the imaging device S6 and a display area representing the positional relation between the shovel 100 and a detected person. The display device 40 can display a menu screen or the like. The display device 40 is operated by receiving power from the storage battery 70. The display device 40 includes a control part 40a, an image display part 42, and an operation part 43.

The control part 40a controls an image displayed on the image display part 42. The control part 40a is a computer including a CPU, RAM, NVRAM, ROM, and the like. The control part 40a reads a program corresponding to each functional element from the ROM, reads it into the RAM, and causes the CPU to execute the corresponding processing. However, each functional element may be composed of hardware or a combination of software and hardware. The image displayed on the image display part 42 may be controlled by the controller 30 or the imaging device S6.

The image display part 42 may display a menu screen when the operation part 43 receives a menu display operation, regardless of whether the shovel 100 is operable or inoperable. The image display part 42 may display a menu screen when the operation part 43 receives a menu display operation only when the shovel 100 is inoperable. Further, these may be configured to be switchable by a switching means such as a switching switch. The operable state of the shovel 100 is, for example, a state in which the operating device 26 is enabled when the gate lock lever 55 is pulled up and the selector valve 18 is opened. The state of the gate lock lever 55 at this time is referred to as an unlocked state. The inoperable state of the shovel 100 is, for example, a state in which the operating device 26 is disabled when the gate lock lever 55 is pushed down and the selector valve 18 is closed. The state of the gate lock lever 55 at this time is referred to as a locked state. Next, the display after shifting to the unlocked state will be described.

The image display part 42 displays image information captured by at least one of the imaging devices S6 and a shovel state display area showing the state of the shovel 100 and the positional relation between the shovel 100 and the person, in accordance with control by the control part 40a. The specific display contents of the shovel state display area will be described later.

The image display part 42 according to the present embodiment is an example of displaying a rearward image captured by the camera S6B and a rightward image captured by the camera S6R out of the image information captured by the imaging device S6.

The present embodiment does not limit the display mode of the image information captured by the imaging device S6. The image information displayed on the image display part 42 may be, for example, any of a front image captured by the camera S6F, a rearward image captured by the camera S6B, a leftward image captured by the camera S6L, and a rightward image captured by the camera S6R. The image information may be two or more images selected from a front image, a rearward image, a leftward image, and a rightward image. Further, the image display part 42 may display a shovel state display area representing the positional relation between the shovel 100 and the detected person, and may not display image information captured by the imaging device S6.

The operation part 43 is a touch panel provided on the display area of the image display part 42. The operation part 43 receives an operation (e.g., operations on the menu screen) to change the screen displayed by the image display part 42. The information that can be received by the operation part 43 using the touch panel is not particularly limited.

In the present embodiment, the operation part 43 is not limited to a touch panel, but may be a switch panel including hardware. Note that, the operation part 43 may be a switch panel, and the display device 40 may be a configuration that allows input using physical buttons instead of the operation part 43 that is a touch panel. The operation part 43 may be a combination of a touch panel and physical buttons. The operation part 43 is not limited to a mode provided in the display device 40, and may be disposed on an operation lever, for example, or on a left seat console or a right seat console on both left and right sides of the operator's seat. In addition to the operation part 43 provided in the display device 40, an operator's seat operation part having the same function as the operation part 43 may be provided in at least one of the operating lever, the left seat console, and the right seat console.

The display device 40 is merely an example and is not limited to the display devices described herein. The shovel 100 is not limited to the display device 40. A person skilled in the art can appropriately design the display device 40.

The display device 40 is not limited to a device provided in advance in the cabin 10, and may be a monitor that can be placed separately. Further, the display device 40 may be any device that can display, and may be, for example, a tablet terminal or the like that can communicate with the communication device T1.

### [Functional Configuration of Controller]

The controller 30 (an example of a control device) is provided in the cabin 10, for example, and performs drive control of the shovel 100. The functions of the controller 30 may be achieved by arbitrary hardware, software, or a combination thereof. For example, the controller 30 is configured around a microcomputer including a central processing unit (CPU), a read only memory (ROM), a random access memory (RAM), a nonvolatile auxiliary storage medium, and various input and output interfaces. The controller 30 achieves various functions by executing various programs stored in a ROM or a nonvolatile auxiliary storage medium on the CPU, for example.

For example, the controller 30 sets a target rotation speed based on an operation by an operator or the like, and performs drive control to make the engine 11 rotate at a constant speed.

For example, the controller 30 outputs a control command to the regulator 14a as needed to change the discharge amount of the main pump 14.

For example, the controller 30 performs control related to a machine guidance function that guides a manual operation of the shovel 100 by an operator through the operating device 26. Further, the controller 30 controls a machine control function that automatically supports the manual operation of the shovel 100 by the operator through the operating device 26, for example.

A part of the function of the controller 30 may be implemented by another controller (control device). That is, the function of the controller 30 may be implemented in a manner distributed by a plurality of controllers. For example, the machine guidance function and the machine control function may be implemented by a dedicated controller (control device).

Referring back to FIG. 3, a configuration in which the controller 30 performs control based on the detected person will be described. The controller 30 achieves an acquisition part 30a, a detection part 30b, a position estimation part 30c, and an output control part 30d as the machine guidance function and the machine control function by executing a program stored in a storage medium (not shown).

The acquisition part 30a acquires detection results from various sensors provided in the shovel 100. For example, the acquisition part 30a acquires image information indicating the imaging result from the imaging device S6 via the display device 40. The acquisition part 30a acquires the swivel angle of the upper swivel body 3 from the swivel angle sensor (an example of an angle detection device) S5.

The detection part 30b performs detection processing of a person existing around the shovel 100 from the image information acquired by the acquisition part 30a. Any method may be used for the detection processing of the person regardless of the known method. For example, it may be determined whether or not the feature extracted from the image information approximates a predetermined feature indicating a person by a predetermined value or more. When a person is detected, the detection part 30b outputs information (for example, position coordinates) indicating an area where the person appears in the image information.

When a person is detected by the detection part 30b, the position estimation part 30c estimates the position of the person in the real space, for example, the direction and distance in which the person exists based on the shovel 100. For example, the position estimation part 30c may estimate the direction and distance in which the person exists based on the position and size in which the person appears in the image information. Further, when LIDAR, a range image camera, or a millimeter wave radar is mounted as the object detection device in addition to the imaging device S6, the direction and distance in which the person exists may be estimated from the detection result by the object detection device. The position estimation part 30c according to the present embodiment will explain an example of acquiring the direction and distance in which the person exists with reference to the shovel 100 as the position information of the person existing around the shovel. However, the position information of the person is not limited to the direction and distance in which the person exists with reference to the shovel 100, and information indicating the position coordinates of the person in the world coordinate system may be acquired, for example.

In the present embodiment, the detection of the person and the estimation of the position of the person are not limited to the above-described methods, and the detection of the person and the estimation of the position (e.g., the direction and distance) of the person may be performed using a trained model.

For example, the trained model is formed by a neural network. The neural network of the trained model may use what is called a deep neural network having one or more intermediate layers (hidden layers) between the input layer and the output layer. In the neural network, a weighting parameter representing the connection strength between the lower layer and each of the plurality of neurons constituting the respective intermediate layers is specified. The neural network is configured in such a manner that the neurons of each layer output the sum of the values obtained by multiplying the input values from the plurality of neurons of the upper layer by the weighting parameter specified for each neuron of the upper layer to the neurons of the lower layer through a threshold function.

Then, as a result of machine learning, specifically, deep learning, performed on the trained model, optimization of the weighting parameters of the neural network is tried.

The training data used in the machine learning includes, for example, image information, information indicating whether or not a person appears in the image information, information indicating an area where a person appears in the image information, and information relating to the position of the person in the real space (e.g., direction and distance). By performing machine learning using the training data, when the image information is input, the trained model may output information indicating whether or not a person appears in the image information, an area where a person appears in the image information, and a position where the person exists (e.g., direction and distance). As described above, any method may be used to detect a person and estimate the position of the person regardless of the known method.

Note that the present embodiment is not limited to a method of detecting a person and estimating the position of the person by the controller 30, and may be performed in the imaging device S6 or may use an external cloud service.

The output control part 30d outputs the swivel angle, information indicating an area where a person appears in the image information, position information of a person existing around the shovel 100 (information indicating the direction and distance of the detected person), and detection results of various sensors to the control part 40a of the display device 40. As a result, the display device 40 displays a screen showing the surroundings of the shovel 100 on the image display part 42.

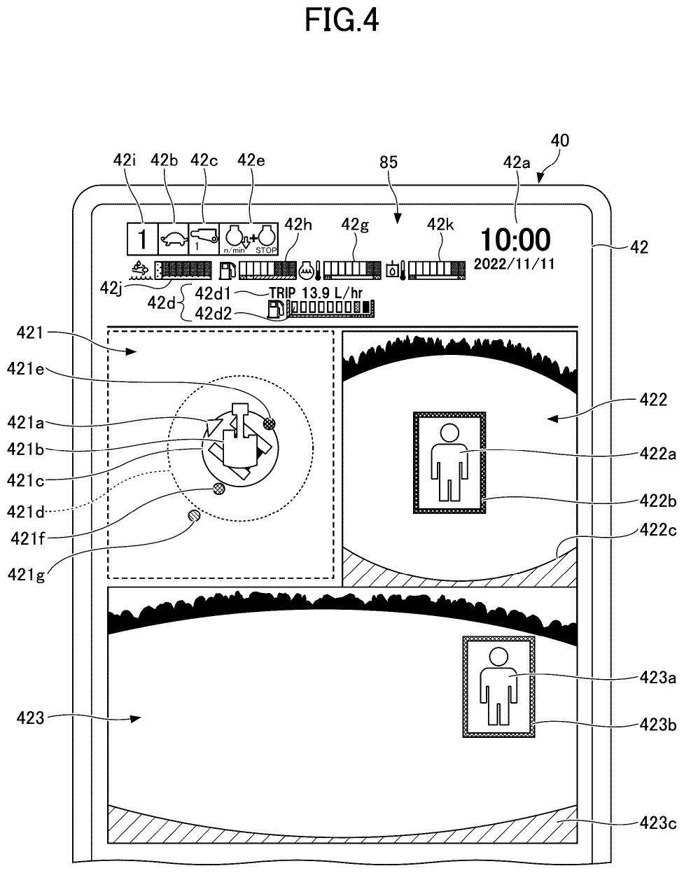

Next, an example of the display screen 85 displayed on the image display part 42 will be described with reference to FIG. 4. FIG. 4 is a drawing illustrating an example of the display screen 85 displayed by a display device 40 according to the present embodiment. The display screen 85 is displayed on the image display part 42 during the operation of the shovel 100.

The control part 40a according to the present embodiment generates the display screen 85 based on the image information input from the imaging device S6 and various kinds of information received from the controller 30. The information received from the controller 30 includes a swivel angle, information indicating an area where a person appears in the image information, position information of a person existing around the shovel (information indicating the direction and distance of the detected person), and detection results of various sensors.

The display screen 85 including a date and time display area 42a, a travel mode display area 42b, an attachment display area 42c, a fuel consumption display area 42d, an engine control state display area 42e, an engine operating time display area, a cooling water temperature display area 42g, a remaining fuel amount display area 42h, a rotation speed level display area 42i, a remaining urea water amount display area 42j, a hydraulic fluid temperature display area 42k, a shovel state display area 421, a first image display part 422, and a second image display part 423 is displayed on the image display part 42 in accordance with control from the control part 40a. The display screen 85 may include other display areas.

The travel mode display area 42b, the attachment display area 42c, the engine control state display area 42e, and the rotation speed level display area 42i are areas to display setting state information that is information related to the setting state of the shovel 100. The fuel consumption display area 42d, the engine operating time display area, the cooling water temperature display area 42g, the remaining fuel amount display area 42h, the remaining urea water amount display area 42j, and the hydraulic fluid temperature display area 42k are areas to display operating state information that is information indicating the operating state of the shovel 100 based on the detection results of various sensors.

The date and time display area 42a is an area to display the current date and time. The travel mode display area 42b is an area to display the current travel mode. The attachment display area 42c is an area to display an image representing the currently attached attachment. The fuel consumption display area 42d is an area to display fuel consumption information calculated by the controller 30. The fuel consumption display area 42d includes an average fuel consumption display area 42d1 to display lifetime average fuel consumption or section average fuel consumption, and an instantaneous fuel consumption display area 42d2 to display instantaneous fuel consumption.

The engine control state display area 42e is an area to display the control state of the engine 11. The engine operating time display area is an area to display the cumulative operating time of the engine 11. The cooling water temperature display area 42g is an area to display the current temperature state of the engine cooling water. The remaining fuel amount display area 42h is an area to display the remaining fuel amount state stored in the fuel tank.

The rotation speed level display area 42i is an area to display the current level set by the dial 32 in an image. A number indicating a selected level is displayed in the rotation speed level display area 42i. “1” displayed in the rotation speed level display area 42i indicates that the selected rotation speed level is the “first level”. The number “n” displayed in the rotation speed level display area 42i indicates that the selected rotation speed level is the “nth level”. “n” is a natural number. When the operator rotates the dial 32, the number displayed in the rotation speed level display area 42i changes.

The remaining urea water amount display area 42j is an area to display the remaining amount of urea water stored in the urea water tank in an image. The hydraulic fluid temperature display area 42k is an area to display the temperature of the hydraulic fluid in the hydraulic fluid tank.

The shovel state display area 421 is an area to display information representing the positional relation between the shovel 100 and a person detected around the shovel 100.

The shovel state display area (an example of a predetermined display area) 421 is a display area representing an actual space centering on the shovel 100 at a predetermined scale rate. In the shovel state display area (an example of a predetermined display area) 421, a shovel icon 421b indicating the presence of the shovel 100 is arranged at the center of the area.

In the shovel state display area (an example of a predetermined display area) 421, in addition to the shovel icon (an example of the first display information) 421b representing the shovel 100, an icon indicating the direction in which the shovel 100 can travel (a direction display icon 421a in the example of FIG. 4) and an icon representing a person detected from around the shovel 100 (in the example of FIG. 4, the person detection icons 421e, 421f, 421g) are simultaneously displayed. In the shovel state display area 421, an area (in other words, a background) other than the shovel icon 421b, the direction display icon 421a, and the person detection icons 421e, 421f, and 421g may be, for example, an area represented by a single color (for example, black).

The shovel icon (an example of the first display information) 421b is an icon obtained by combining an image representing the upper swivel body 3 and an image representing the lower traveling body 1 in accordance with the positional relation between the upper swivel body 3 and the lower traveling body 1 based on the swivel angle.

The direction display icon (an example of the third display information) 421a is a triangular shape indicating the direction in which the shovel 100 travels when the traveling lever is pushed forward. The present embodiment shows an example of an icon indicating the direction in which the shovel 100 travels when the traveling lever is pushed forward, and may have any shape as long as the shape indicates the direction in which the shovel 100 can travel.

The person detection icons (an example of the second display information) 421e, 421f, and 421g are icons representing people detected by the image information captured by the imaging device S6. Specifically, the person detection icons (an example of the second display information) 421e, 421f, and 421g are arranged based on the position information of a person received from the controller 30. For example, the person detection icons 421e, 421f, and 421g (an example of the second display information) are arranged at positions obtained by multiplying the direction and distance of the detected person with respect to the shovel 100 by a predetermined scale factor.

As described above, the positional relation between the shovel icon 421b and the person detection icons 421e, 421f, and 421g corresponds to the positional relation between the shovel 100 and the people around the shovel 100 in the real space.

Note that, there has been a technology to display the situation around the shovel by a bird's-eye image or the like. The bird's-eye image is generated by synthesizing image information captured by, for example, an imaging device provided on the shovel. In such a bird's-eye image, in addition to the shovel and the people detected around the shovel, objects and the like around the shovel are also displayed. Furthermore, the situation of the ground is also displayed. Therefore, since the operator of the shovel recognizes information about various objects, while referring to the bird's-eye image, grasping the people around the shovel is sometimes difficult.

Conversely, in the present embodiment, an icon (e.g., shovel icon 421b) indicating the shovel 100, an icon (e.g., the direction indicator icon 421a) indicating the direction in which the shovel 100 can move, and an icon (e.g., people detection icons 421e, 421f, 421g) indicating a person detected from around the shovel 100 are displayed in the shovel state display area (one example of a predetermined display area) 421. In other words, an object other than a person existing around the shovel is prevented from being displayed in the shovel state display area (one example of a predetermined display area) 421.

That is, by referring to the shovel state display area 421, the operator can recognize the current state of the shovel 100, the direction in which the shovel can proceed, and the positional relation between the shovel and the person around the shovel 100.

Further, the operator can estimate how the positional relation between the shovel 100 and the surrounding people changes when the shovel 100 is moved by referring to the shovel state display area 421. Furthermore, since the display of objects other than the shovel and the person is suppressed in the shovel state display area 421, it is possible to suppress the operator from being attracted to other objects and forgetting the presence of the person. Therefore, the safety can be improved.

Also, in the shovel state display area (an example of a predetermined display area) 421, a first circular area (an example of the first area) 421c and a second circular area (an example of the first area) 421d determined in accordance with the distance from the shovel 100 with the shovel 100 as a reference are displayed.

A first circular area (an example of the first area) 421c and a second circular area (an example of the first area) 421d shown in FIG. 4 are represented as circles to allow the operator to recognize the relative distance from the shovel 100 with reference to the shovel icon 421b.

The first circular area 421c is information indicating the range in which the current attachment AT of the shovel 100 rotates based on the detection results of the boom angle sensor S1, the arm angle sensor S2, and the bucket angle sensor S3.

The second circular area 421d is information indicating a range in which the attachment AT rotates when the attachment AT is most extended in the horizontal direction.

The image display part 42 according to the present embodiment displays the first circular area 421c and the second circular area 421d. That is, the positional relation between the person and the attachment AT can be recognized by the positional relation between the first circular area 421c and the second circular area 421d and the person detection icons 421e, 421f, and 421g. Therefore, the operator can easily perform an operation in which the person does not come into contact with the attachment AT, thereby improving safety.

Further, the control part 40a differentiates the display mode of the person detection icons 421e, 421f, and 421g according to whether or not they are included in the first circular area (an example of the first area) 421c and the second circular area (an example of the first area) 421d.

For example, the person detection icon 421e existing in the first circular area 421c is displayed in red. The person detection icon 421f existing outside the first circular area 421c but in the second circular area 421d is displayed in yellow, for example. The person detection icon 421g existing outside the second circular area 421d is displayed in blue, for example. The control part 40a according to the present embodiment differentiates the display mode depending on whether or not the person is included in the first circular area (an example of the first area) 421c and the second circular area (an example of the first area) 421d. In other words, the color of the person detection icon is changed according to the distance from the shovel 100. Thus, by displaying the person detection icon whose color is changed according to the distance, the display device 40 can alert the operator according to the distance between the shovel 100 and the person. Therefore, the safety can be improved.

The color of the person detection icon of the present embodiment is an example, and is not limited to the color. For example, the person detection icon may be displayed in gray scale. The color change of the person detection icon of the present embodiment is an example of the display mode, and is not limited to the color change. For example, the blinking cycle of the person detection icon may be differentiated, the contrast or the luminance may be differentiated, or the like, depending on whether the person detection icon is included in the first circular area (an example of the first area) 421c and the second circular area (an example of the first area) 421d.

FIG. 4 also shows an example in which one person detection icon is displayed in each area within the first circular area (an example of the first area) 421c, outside the first circular area (an example of the first area) 421c, and inside the second circular area (an example of the first area) 421d, and outside the second circular area (an example of the first area) 421d. However, a plurality of person detection icons may be displayed in each area in accordance with the result of the person detection. When a plurality of person detection icons are present in each area, a plurality of person detection icons existing in one area may be displayed in a distinguishable manner.

For example, when a plurality of person detection icons are existing in each area, a unique number may be assigned to each person detection icon and displayed. Further, the shape of each person detection icon may be displayed so as to be changed. In addition, the person existing in each area can be uniquely recognized by this display. Therefore, even when a plurality of people are present, the operator can operate the shovel 100 after recognizing each person, so that safety can be improved.

By referring to the shovel state display area 421, the operator can recognize how the positional relation between the attachment AT of the shovel 100 and the surrounding persons changes when the shovel 100 is swiveled. Therefore, safety can be improved.

Although the present embodiment describes an example in which the first circular area 421c and the second circular area 421d are displayed, the present embodiment is not limited to an example in which the first circular area 421c and the second circular area 421d are displayed, but any one of the first circular area 421c and the second circular area 421d may be used.

Furthermore, the shovel state display area (an example of a predetermined display area) 421 is not limited to a method in which a circular area indicating a range in which the attachment AT is swiveled is displayed in order to recognize a distance between the shovel 100 and a person, but may represent a circular area indicating a predetermined distance (e.g., 4 m) around the shovel 100.

On the image display part 42, a shovel state display area 421 is displayed and image information captured by the imaging device S6 is displayed. By confirming the image information together with the shovel state display area 421, the operator can recognize a specific situation around the shovel 100. Therefore, safety can be improved.

On the screen shown in FIG. 4, the first image display part 422 and the second image display part 423 are areas to display image information captured by the imaging device S6. The first image display part 422 displays a rightward image. The second image display part 423 displays a rearward image. The rightward image is an image showing the space on the right direction of the shovel 100, and includes an image 422c of the right end of the upper surface of the upper swivel body 3. The rightward image is a viewpoint image generated by the control part 40a, and is generated based on an image acquired by the camera S6R. The rearward image is an image projecting a space behind the shovel 100 and includes a counterweight image 423c. The rearward image is a viewpoint image generated by the control part 40a and is generated based on an image acquired by the camera S6B.

The first image display part 422 is displayed to the right with respect to the shovel state display area 421. The second image display part 423 is displayed below with respect to the shovel state display area 421. In the present embodiment, the upper portion of the image display part 42 corresponds to the front portion of the upper swivel body 3. In other words, the second image display part 423 is displayed at a position corresponding to the rear portion with respect to the shovel state display area 421. That is, the image display part 42 displays the image information captured by the imaging device S6 in the direction of image capturing by the imaging device S6 with respect to the shovel state display area 421. In the present embodiment, since the captured image information is displayed in the direction of image capturing with respect to the shovel state display area 421, the operator can intuitively recognize which direction the image information represents when referring to the image information. Therefore, the safety can be improved.

Note that the present embodiment shows an example of the arrangement of the image information, and is not limited to the arrangement. For example, the first image display part 422 and the second image display part 423 may be arranged regardless of the imaging direction.

When the controller 30 detects a person from one or more of the rightward image and the rearward image, it transmits information indicating the area where the person has been detected to the control part 40a.

The control part 40a superimposes a frame indicating information indicating the area where the person has been detected on the image of the rightward image and the rearward image based on the received information.

As a result, the frame 422b is displayed on the rightward image of the first image display part 422, and the frame 423b is displayed on the rearward image of the second image display part 423.

The control part 40a matches the color of the frame 422b of the rightward image of the first image display part 422 with the color of the person detection icon 421e, and matches the color of the frame 423b of the rearward image of the second image display part 423 with the color of the person detection icon 421f.

That is, the image display part 42 displays a frame indicating the detected person on the rightward image and the rearward image, and also displays the correspondence relation between the person indicated by the frame and the person detection icon in a recognizable manner. Thus, the operator can recognize the situation of the person indicated on the shovel state display area 421 by referring to the rightward image and the rearward image. Therefore, the operator can operate the shovel 100 in consideration of the situation of the people around the shovel 100. Therefore, the safety can be improved. In the present embodiment, an example of matching the color of the frame with the color of the person detection icon has been described as an example of a display in which the correspondence relation can be recognized. However, the present embodiment shows an example of a display in which the correspondence relation can be recognized, and is not limited to a method of matching the color of the frame with the color of the person detection icon. For example, the correspondence relation may be recognized in a blinking cycle between the frame and the person detection icon.

As described above, the color of the person detection icon is changed in accordance with the distance to the shovel 100. The person detection icon in the shovel state display area 421 is matched with the color of the frame displayed on the rightward image and the rearward image. Therefore, the image display part 42 is configured to display the frame (an example of a display mode) shown on the rightward image and the rearward image in different colors based on the distance between the shovel 100 and the person. In the present embodiment, since the color of the frame shown on the rightward image and the rearward image is changed in accordance with the distance to the shovel 100, the operator can recognize the distance to the shovel 100 when referring to the color of the frame. Therefore, since the operator can operate according to the distance, the safety can be improved.

In the present embodiment, the control part 40a displays the display screen 85 on the image display part 42, so that the operator can grasp the situation around the shovel 100.

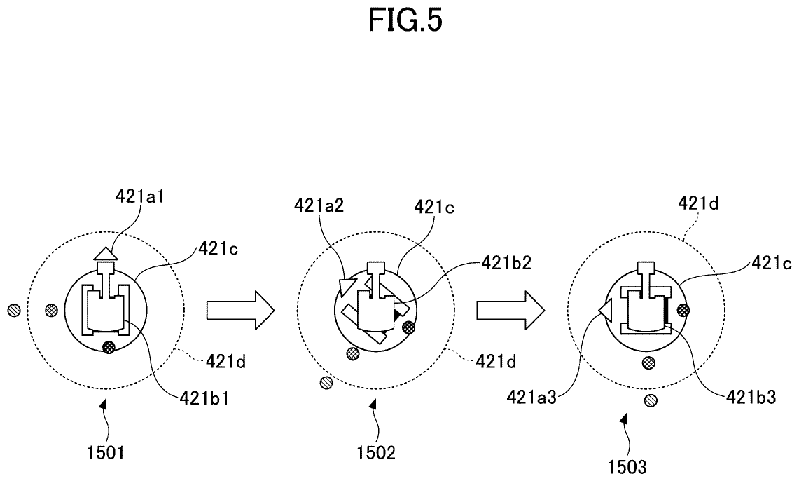

Next, the shovel icon 421b will be described. FIG. 5 is a drawing illustrating changes in the shovel icon 421b and the direction display icon 421a displayed on the image display part 42 according to the present embodiment.

In the example shown in the state 1501 of FIG. 5, a direction display icon 421a1, a shovel icon 421b1, a first circular area 421c, a second circular area 421d, and a person detection icon are displayed in the shovel state display area 421 on the image display part 42.

Then, the operator performs an operation to swivel the upper swivel body 3. For example, the operator performs an operation to swivel the upper swivel body 3 to the right. Thus, the swiveling of the upper swivel body 3 is started. Then, the control part 40a receives the swivel angle of the upper swivel body 3 from the controller 30.

When the change of the swivel angle is detected, the control part 40a generates and displays a shovel icon 421b2 which shows that the lower traveling body 1 is moved with respect to the upper swivel body 3 based on the changed swivel angle as shown in the state 1502. Further, the control part 40a displays a direction display icon 421a2 which shows the direction in which the lower traveling body 1 represented by the shovel icon 421b2 can move. The position of the person detection icon also changes based on the change in the swivel angle.

Further, the operator continues the operation of swiveling the upper swivel body 3. Then, the control part 40a receives the swivel angle of the upper swivel body 3 from the controller 30.

When a further change in the swivel angle is detected, the control part 40a generates and displays a shovel icon 421b3 which shows that the lower traveling body 1 has been moved with respect to the upper swivel body 3 based on the changed swivel angle, as shown in the state 1503. Further, the control part 40a displays a direction display icon 421a3 which shows the direction in which the lower traveling body 1 represented by the shovel icon 421b3 can move. The position of the person detection icon also changes based on the change in the swivel angle.

As shown in the states 1501 to 1503, the control part 40a displays a shovel icon 421b3 on the upper part of the display area of the image display part 42 so that the front of the upper swivel body 3 is represented. Even though the upper swivel body 3 of the shovel 100 has swiveled, the shovel icon 421b is displayed so that the front of the upper swivel body 3 of the shovel 100 is on the upper part of the display area of the image display part 42. That is, the shovel icon 421b is displayed so as to correspond to the viewpoint of the operator. Therefore, the operator can intuitively recognize the angle of the lower traveling body 1 with respect to the upper swivel body 3 by referring to the shovel icon 421b. In other words, the operator on board the cabin 10 can recognize how much the direction in which the lower traveling body 1 travels differs from the direction in which the operator is currently facing when the travel lever is pushed forward. Moreover, the operator can recognize in which direction the detected person exists with respect to the current direction in which the operator is facing by referring to the shovel icon 421b and the person detection icon. Therefore, since the operator can intuitively recognize the situation around the shovel 100, the safety can be improved.

The display of the shovel state display area 421 shown in FIG. 5 is not limited to a method in which the display mode changes in synchronization with the current swivel angle of the upper swivel body 3 during the swiveling of the upper swivel body 3. For example, the display may be performed so that the display mode changes when the swiveling of the upper swivel body 3 is stopped.

### Modification 1 of Embodiment 1

The embodiment described above shows an aspect of the display screen displayed on the image display part 42. The display screen displayed on the image display part 42 is not limited to the display mode of the embodiment described above. Therefore, another aspect of the shovel state display area 421 will be described in the modification of the embodiment 1.

The position estimation part 30c of the controller 30 according to the present modification determines whether or not the detected person exists within a predetermined range in the direction in which the lower traveling body 1 can move in the real space (the real space in which the shovel 100 exists) based on the swivel angle and the direction and distance of the detected person. The position estimation part 30c transmits the determination result as to whether or not the detected person exists within the predetermined range to the control part 40a. The control part 40a changes the display mode in the shovel state display area 421 according to the determination result.

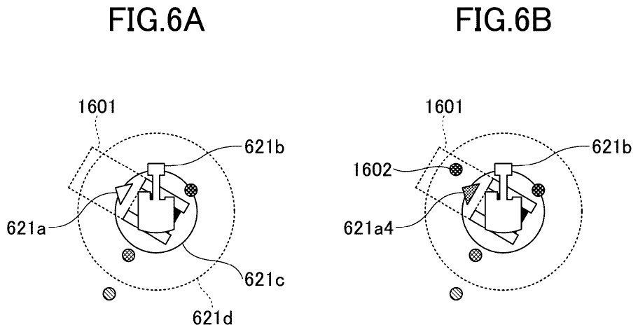

FIGS. 6A and 6B are drawings illustrating changes in the display mode of the shovel state display area 421 displayed by the display device 40 according to the present modification. The shovel state display area 421 changes the display mode in accordance with whether or not a person exists in the movable direction of the lower traveling body 1.

FIG. 6A shows a direction display icon 621a, a shovel icon 621b, a first circular area 621c, and a second circular area 621d in the shovel state display area 621.

The position estimation part 30c of the controller 30 determines whether or not a person exists within a predetermined range of the real space corresponding to the front area 1601 based on the swivel angle and the direction and distance of the detected person. In the example shown in FIG. 6A, since it is determined that no person exists in the real space corresponding to the front area 1601, the image display part 42 displays a screen as usual. A line indicating the front area 1601 may or may not be displayed in the shovel state display area 421.

In FIG. 6B, the position estimation part 30c determines that a person exists within a predetermined range of the real space corresponding to the front area 1601 based on the swivel angle and the direction and distance of the detected person. The presence of a person within the predetermined range means, in other words, that the front area 1601 includes the person detection icon 1602.

In this case, the control part 40a displays the direction display icon 621a4 in the shovel state display area 421 included in the image display part 42 in a color indicating a warning (e.g., red).

This display facilitates for the operator to recognize whether or not a person exists in the movable direction of the lower traveling body 1. Therefore, safety can be improved.

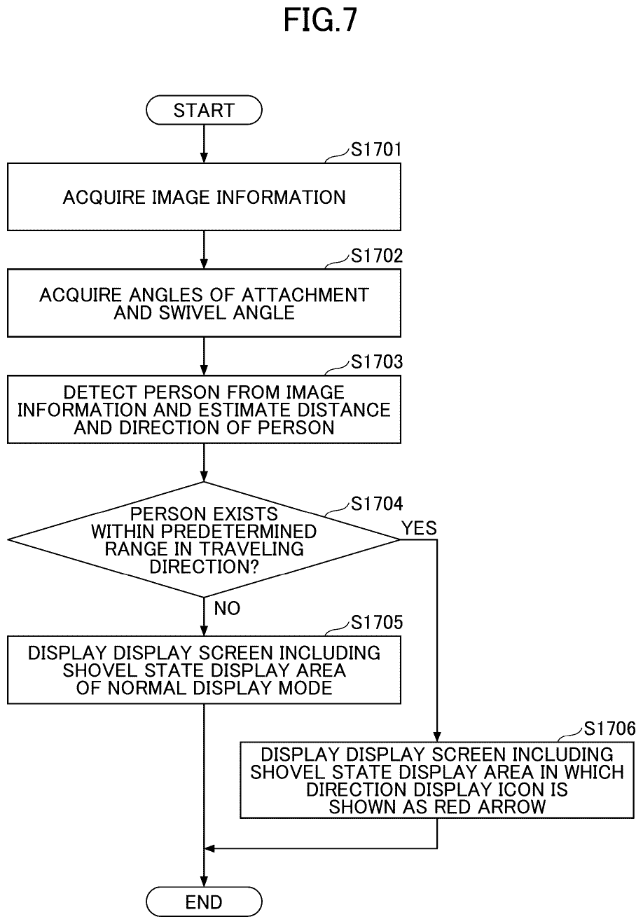

Next, a processing procedure executed by the controller 30 and the display device 40 according to the present modification will be described. FIG. 7 is a flowchart illustrating a processing procedure for displaying the display screen by the controller 30 and the display device 40 according to the present modification.

First, the acquisition part 30a acquires image information captured by the imaging device S6 (S1701).

Next, the acquisition part 30a acquires the angles (boom angle, arm angle, bucket angle) of the attachment from the angle sensors S1 to S3, and acquires the swivel angle from the swivel angle sensor S5 (S1702).

Then, the detection part 30b detects a person from the image information, and the position estimation part 30c estimates the distance and direction to the detected person (S1703).

Then, the position estimation part 30c determines, based on the swivel angle and the distance and direction to the detected person, whether or not a person exists within a predetermined range in the traveling direction of the lower traveling body 1 (S1704).

If the position estimation part 30c determines that no person exists within the predetermined range (S1704: NO), the output control part 30d transmits the determination result indicating that no person exists within the predetermined range and information for generating a display screen to the display device 40.

Then, the control part 40a of the display device 40 displays a display screen including the shovel state display area 421 of the normal display mode together with the image information (S1705).

Conversely, if the position estimation part 30c determines that a person exists within the predetermined range (S1704: YES), the output control part 30d transmits the determination result indicating that a person exists within the predetermined range and information to generate a display screen to the display device 40.

Then, the control part 40a of the display device 40 displays a display screen including the shovel state display area 421 in which the direction display icon is shown in red together with the image information (S1706).

Since the shovel 100 according to the present modification performs the above-described processing, the operator can recognize the situation around the shovel 100, so that the safety can be improved.

### Modification 2 of Embodiment 1

The above-described embodiment shows one aspect of the display screen displayed by the image display part 42. The display screen displayed by the image display part 42 is not limited to the display mode of the above-described embodiment. For example, the above-described embodiment does not limit the number of image information items displayed on the display screen to two. Therefore, in modification 2 of the embodiment 1, a case where the number of image information items to be displayed is changed will be described.

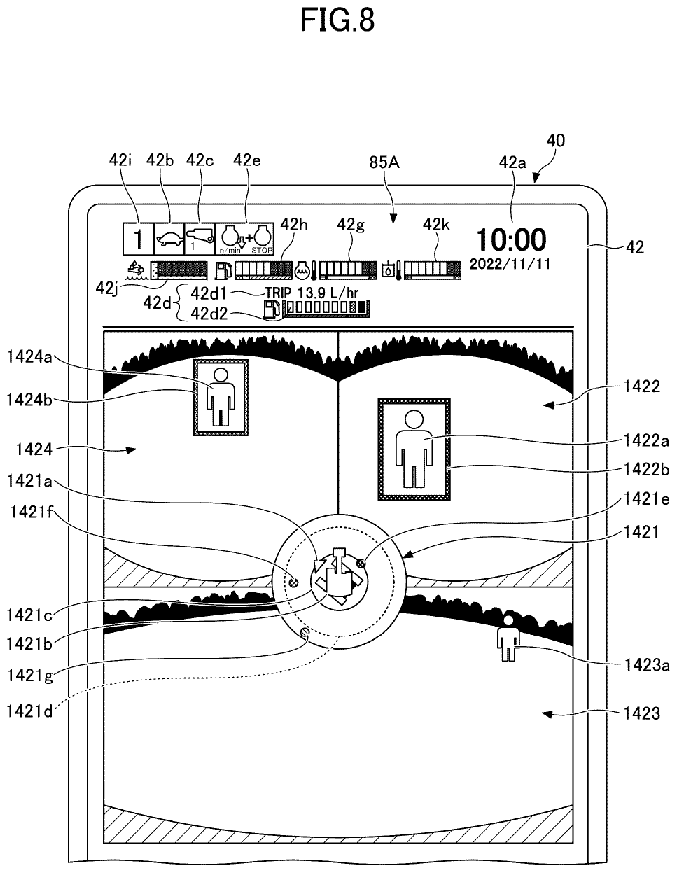

Next, referring to FIG. 8, an example of the display screen 85A displayed by the image display part 42 in accordance with control from the control part 40a will be described. FIG. 8 is a drawing illustrating an example of the display screen 85A displayed by the display device 40 according to modification of the present embodiment. The display screen 85A is displayed on the image display part 42 during the operation of the shovel 100. The same reference numerals are assigned to the same display contents as those in FIG. 4, and the description thereof will be omitted.

The display screen 85A including the shovel state display area 1421, the first image display area 1422, the second image display area 1423, and the third image display area 1424 is displayed on the image display part 42 as the display contents different from those in FIG. 4. Other display areas may be included in the display screen 85A.

The shovel state display area 1421 is an area for displaying information representing the positional relation between the shovel 100 and a person detected around the shovel 100.

The shovel state display area (an example of a predetermined display area) 1421 is a display area representing a real space centering on the shovel 100 at a predetermined scale rate. In the shovel state display area (an example of a predetermined display area) 1421, a shovel icon 1421b indicating the presence of the shovel 100 is arranged at the center of the area.

In the shovel state display area (an example of a predetermined display area) 1421, in addition to the shovel icon 1421b representing the shovel 100 (an example of first display information), an icon indicating the direction in which the shovel 100 can move (a direction display icon 1421a in the example of FIG. 8) and an icon indicating a person detected around the shovel 100 (in the example of FIG. 8, the person detection icons 1421e, 1421f, 1421g) are simultaneously displayed.

In the shovel state display area (an example of a predetermined display area) 1421, a first circular area (an example of a first area) 1421c and a second circular area (an example of a first area) 1421d determined in accordance with the distance from the shovel 100 with the shovel 100 as a reference are displayed.

In the screen shown in FIG. 8, the first image display area 1422, the second image display area 1423, and the third image display area 1424 are areas to display image information captured by the imaging device S6. The first image display area 1422 displays a rightward image. The second image display area 1423 displays a rearward image. The third image display area 1424 displays a leftward image. The rightward image is an image that projects the space to the right of the shovel 100, the rearward image is an image that projects the space to the rear of the shovel 100, and the leftward image is an image that projects the space to the left of the shovel 100. The third image display area 1424 is displayed leftward with respect to the shovel state display area 1421. That is, the image display part 42 displays the image information captured by the imaging device S6 in the direction of image capturing by the imaging device S6 with respect to the shovel state display area 1421. In the present modification, since the leftward image is added as compared with the above-described embodiment, the situation around the shovel 100 can be more readily grasped.

When the controller 30 detects a person from one or more of the rightward image, the rearward image, and the leftward image, information indicating the area where the person was detected is transmitted to the control part 40a.

Then, the control part 40a superimposes a frame indicating information indicating the area in which a person is detected on the image in which the person is detected among the rightward image, the rearward image, and the leftward image.

Thus, the frame 1422b is displayed so as to surround the person 1422a on the rightward image of the first image display area 1422, and the frame 1424b is displayed so as to surround the person 1424a on the leftward image of the third image display area 1424.

Also, a person who exists far from the shovel 100 need not be surrounded by a frame. For example, a person 1423a exists in the rearward image of the second image display area 1423. However, as shown in the shovel state display area 1421, the person detection icon 1421g is outside the second circular area (an example of the first area) 1421d. Therefore, when generating the display screen, the control part 40a suppresses surrounding the person 1423a corresponding to the person detection icon 1421g with a frame in the third image display area 1424. As a result, the frame is not displayed for a person who exists far away to the extent that it is not necessary to pay attention, so that the operator can grasp only the person to be noticed.

### Modification 3 of Embodiment 1

In the first embodiment described above, an example of displaying a rightward image and a rearward image has been described. The display of the leftward image is omitted because the operator only needs to turn left from the cabin 10. However, if there is no leftward image but a person exists in the left direction, it is preferable to make the operator recognize that a person exists on the left direction. Therefore, in modification 2, a display mode for making the operator recognize that a person exists on the left direction will be described.

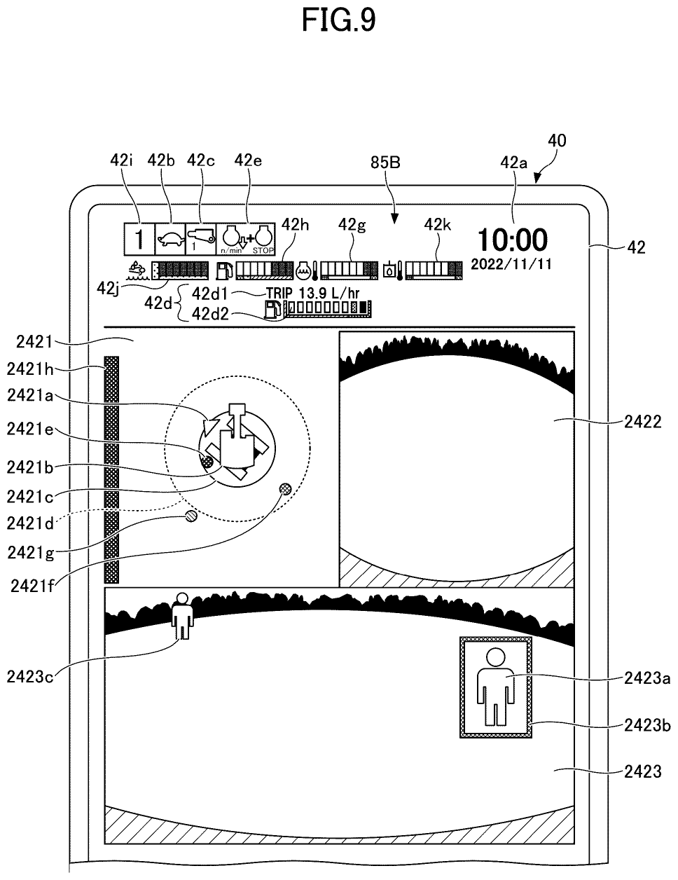

Next, referring to FIG. 9, an example of a display screen 85B displayed by the image display part 42 under control from the control part 40a will be described. FIG. 9 is a drawing illustrating an example of the display screen 85B displayed by the display device 40 according to the present modification. The display screen 85B is displayed on the image display part 42 during the operation of the shovel 100. The same reference numerals are assigned to the same display contents as those in FIG. 4, and the description thereof is omitted.

The image display part 42 displays a display screen 85B including a shovel state display area 2421, a first image display area 2422, and a second image display area 2423. The display screen 85B may include other display areas.

The shovel state display area 2421 is an area to display information indicating the positional relation between the shovel 100 and a person detected around the shovel 100.

The shovel state display area (an example of a predetermined display area) 2421 is a display area representing a real space centering on the shovel 100 at a predetermined scale rate. In the shovel state display area (an example of a predetermined display area) 2421, a shovel icon 2421b indicating the presence of the shovel 100 is arranged at the center of the area.

In the shovel state display area (one example of a predetermined display area) 2421, in addition to the shovel icon (one example of first display information) 2421b representing the shovel 100, an icon indicating the direction in which the shovel 100 can move (direction display icon 2421a in the example of FIG. 9) and an icon indicating a person detected from around the shovel 100 (in the example of FIG. 9, the person detection icons 2421e, 2421f, and 2421g) are simultaneously displayed. In the shovel state display area 2421, a shovel icon (one example of first display information) 2421b and person detection icons 2421e, 2421f, and 2421g are arranged so as to represent the positional relation between the shovel 100 and the detected person.

In the shovel state display area (one example of a predetermined display area) 2421, a first circular area (one example of the first area) 2421c and a second circular area (one example of the first area) 2421d determined in accordance with the distance from the shovel 100 with the shovel 100 as a reference are displayed.

In the screens shown in FIG. 9, the first image display area 2422 and the second image display area 2423 are areas to display image information captured by the imaging device S6. In the first image display area 2422, a rightward image is displayed. In the second image display area 2423, a rearward image is displayed.

The first image display area 2422 is displayed rightward with respect to the shovel state display area 2421. The second image display area 2423 is displayed rearward with respect to the shovel state display area 2421.

When the controller 30 detects a person from one or more of the rightward image and the rearward image, it transmits information indicating the area where the person has been detected to the control part 40a.

The control part 40a superimposes a frame indicating information indicating the area where the person has been detected on the image of the rightward image and the rearward image.

As a result, a frame 2423b is displayed on the rearward image of the second image display area 2423 so as to surround the person 2423a.

Also, a person located far from the shovel 100 may not be surrounded by a frame. For example, a person 2423c is present on the rearward image of the second image display area 2423. However, as shown in the shovel state display area 2421, the person detection icon 2421g is located outside the second circular area (an example of the first area) 2421d. Therefore, when generating the display screen, the control part 40a suppresses surrounding the person 2423c corresponding to the person detection icon 2421g with a frame in the second image display area 2423. As a result, the frame is not displayed for a person who exists far enough that it is not necessary to pay attention, so that the operator can identify only the person who needs attention.

Further, the controller 30 according to the present modification detects a person from the space on the left direction of the shovel 100 based on the image information captured by the imaging device S6. Therefore, the position information (indicating the position where the person exists) transmitted from the output control part 30d to the control part 40a includes the position information of the person detected from the space in the left direction of the shovel 100.

Based on the received position information, the control part 40a determines whether or not a person exists in the area not represented as image information. When it is determined that a person exists in an area not represented as image information, the control part 40a arranges display information (e.g., image information 2421h) representing the presence of a person in the shovel state display area 1421 in the direction in which the person exists with reference to the shovel icon 2421b.

In the present modification, image information 2421h indicating that a person has been detected from the left space is displayed in the shovel state display area (one example of a predetermined display area) 2421 shown in FIG. 9.

The control part 40a matches the color of the image information 2421h with the color of the person detection icon 2421e.

That is, when a person is detected from a direction not displayed as the first image display area 2422 and the second image display area 2423, the control part 40a displays bar-shaped image information (e.g., image information 2421h) in the shovel state display area 1421 in the direction in which the person has been detected on the image display part 42. The color of the bar-shaped image information corresponds to the color of the person detection icon 2421e, so that the operator can recognize the corresponding relation.

Thus, by referring to the display screen 85B, the operator can recognize the presence of the person even when the person not captured in the image information exists near the shovel 100.

When a person is detected from a direction not displayed as the first image display area 2422 and the second image display area 2423, the control part 40a according to the present modification displays bar-shaped image information (e.g., image information 2421h) at a position corresponding to the direction, so that the operator can recognize the presence of the person. Therefore, the safety can be improved.

In the present modification, the display of the bar-shaped image information is not limited to the case where a person is detected from a direction not displayed in each of the first image display area 2422 and the second image display area 2423, but may be performed when a person is detected in the first image display area 2422 or the second image display area 2423.

### Embodiment 2

In the embodiment 2, a case where an operator remotely operates the shovel 100 will be described.

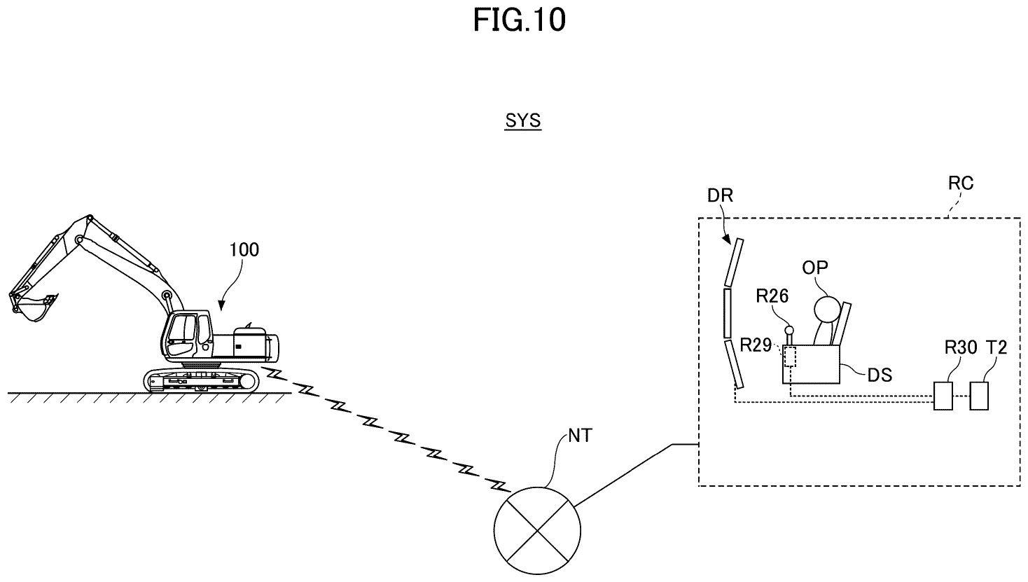

FIG. 10 is a schematic view illustrating an example of a configuration of a remote support system SYS of the shovel 100 according to another embodiment. In the example shown in FIG. 10, the shovel 100 and the remote control room RC are connected via the communication network NW. Thus, transmission and reception of information can be achieved between the shovel 100 and the remote control room RC.

The shovel 100 transmits detection results from various sensors provided in the shovel 100 to the remote control room RC by using the communication device T1 provided in the shovel 100. For example, the shovel 100 transmits image information captured by the imaging device S6, a swivel angle, an area where a person appears in the image information, position information of a person existing around the shovel (information indicating the direction and distance of the detected person), and detection results of various sensors to the remote control room RC.

In the remote support system SYS according to the present embodiment, the remote control room RC is provided. The remote control room RC is provided with a display device DR, an operating device R26, an operation sensor R29, an operation seat DS, a remote controller R30, and a communication device T2.

The remote controller R30 displays on the display device DR a display screen based on the image information captured by the imaging device S6, a swivel angle, an area where a person appears in the image information, position information of a person existing around the shovel (information indicating the direction and distance of the detected person), and detection results of various sensors. Thus, the operator OP present in the operation seat DS can check the situation around the shovel 100 even when the operator is present in the remote control room RC.

On the display screen, a shovel state display area is displayed together with image information representing the surroundings of the shovel 100. The description of the shovel state display area is omitted as in the above-described embodiment. The arrangement relation between the shovel state display area and the image information representing the surroundings of the shovel 100 may be any manner. The image information based on the shovel state display area may be arranged as in the above-described embodiment and the modified example.

The operator OP existing in the operation seat DS of the remote control room RC performs an operation on the operating device R26. The operation sensor R29 detects the operation contents received by the operating device R26. The controller 30 generates a control signal corresponding to the operation contents. The communication device T2 transmits the generated control signal to the shovel 100. The remote controller R30 transmits the control signal so that the shovel 100 can be remotely operated.

Thus, the operator OP can recognize a person existing around the shovel 100 as in the above-described embodiment and modification.

### Modification of Embodiment 2

The above-described embodiment has described a case where the operator does not board the cabin 10 to perform remote control from the remote control room RC. However, the above-described embodiment does not limit the case where the operator does not board the cabin 10 to the case where remote control is performed, and autonomous control may be performed by the shovel 100.

In the present case, there may be a remote monitoring system to monitor the shovel 100 performing autonomous control. A monitor may monitor the shovel 100 from a monitor provided in the remote monitoring system. The monitor may check the situation around the shovel 100 by referring to the shovel state display area together with the image information captured from the imaging device S6 as in the above-described embodiment and the modified example. Thus, the safety can be improved.

### <Operation>

In the embodiments and the modifications described above, the traveling direction of the shovel 100 can be recognized by the shovel icon, and the positional relation between the shovel and the person can be recognized from the positional relation between the shovel icon and the person detection icon. Therefore, the operator can recognize the positional relation between the shovel 100 and the person and operate the shovel 100 even when various objects exist around the shovel 100. Therefore, the safety can be improved. Also, the operator can smoothly perform the work, so the productivity can be improved.

Thus, embodiments of the shovels, display devices, and shovel control systems according to the present disclosure, but it should be understood that the invention is not limited to the above-described embodiments. It may be modified into various forms on the basis of the spirit of the invention. Additionally, the modifications are included in the scope of the invention.

What is claimed is:

1. A shovel comprising:
a lower traveling body;
an upper swivel body capable of swiveling with respect to the lower traveling body;
an object detection device provided on the upper swivel body and configured to detect an object existing around the shovel;
an angle detection device configured to detect a swivel angle of the upper swivel body with respect to the lower traveling body;
a control device configured to acquire the swivel angle and positional information about a person existing around the shovel from a detection result of the object detection device; and
a display device configured simultaneously to display first display information and second display information in a predetermined display area in a manner that represents a positional relation between the shovel and the person, the first display information representing the shovel based on the swivel angle in such a manner that the angle between the upper swivel body and the lower traveling body can be recognized, and the second display information representing the person existing at a position indicated by the positional information.

2. The shovel according to claim 1, wherein when a change in the swivel angle is detected, the display device is configured to display the first display information in which the lower traveling body is moved based on the swivel angle, and configured to display third display information representing a direction in which the lower traveling body of the shovel can move, the lower traveling body of the shovel being represented by the first display information.

3. The shovel according to claim 2, wherein the display device is configured to display the first display information such that a front of the upper swivel body is shown on an upper part of a display area of the display device.

4. The shovel according to claim 2, wherein the display device is configured to change a display mode in the predetermined display area when the person is detected in the direction represented by the third display information.

5. The shovel according to claim 2, wherein the display device is configured to display a plurality of first areas, which are determined in accordance with a distance from the shovel, in the predetermined display area, and configured to differentiate the display mode of the second display information according to whether or not the second display information is included in a corresponding first area of the first areas.

6. The shovel according to claim 5, wherein when a plurality of portions of the second display information are included in one of the first areas, the display device is configured to display the plurality of portions of the second display information distinguishably.

7. The shovel according to claim 5, wherein the first areas displayed by the display device are based on the first display information, and are at least one of a range in which a current attachment of the shovel rotates, or a range in which the attachment of the shovel rotates when the attachment of the shovel is most extended in a horizontal direction.

8. The shovel according to claim 1, wherein the object detection device includes an imaging device configured to capture an image of an object existing around the shovel, and wherein the display device is configured to display image information captured by the imaging device in addition to displaying the first display information and the second display information in the predetermined display area.

9. The shovel according to claim 8, wherein the display device is configured to display an area indicating the person detected from the image information on the image information, and also configured to display in such a manner that a correspondence between the person displayed in the area and the person represented by the second display information can be recognized.

10. The shovel according to claim 9,
wherein the display device is configured to differentiate the display mode of the area shown on the image information, and the second image information, based on the distance between the shovel and the person.

11. The shovel according to claim 8, wherein the display device is configured to display the image information captured by the imaging device in a direction in which the imaging device captures images, with respect to the predetermined display area.

12. The shovel according to claim 8, wherein in response to determining that a person exists in an area not represented as the image information based on the position information, the display device is configured to arrange display information indicating that a person exists, in a direction in which the person exists, in the predetermined display area.

13. A display device configured simultaneously to display first display information and second display information in a predetermined display area in a manner that represents a positional relation between a shovel and a person, the first display information representing the shovel based on a swivel angle of an upper swivel body with respect to a lower traveling body of the shovel in such a manner that an angle between the upper swivel body and the lower traveling body can be recognized, and the second display information representing the person detected by an object detection device provided on the upper swivel body.

14. A shovel control system comprising a shovel and a control device, the shovel including:
a lower traveling body;
an upper swivel body capable of swiveling with respect to the lower traveling body;
an object detection device provided on the upper swivel body and configured to detect an object existing around the shovel;
an angle detection device configured to detect a swivel angle of the upper swivel body with respect to the lower traveling body; and
a first communication device configured to transmit the swivel angle and positional information about a person existing around the shovel from a detection result of the object detection device, and
the control device including:
a second communication device configured to receive the swivel angle and the positional information; and
a display device configured simultaneously to display first display information and second display information in a predetermined display area in a manner that represents a positional relation between the shovel and the person, the first display information representing the shovel based on the swivel angle in such a manner that the angle between the upper swivel body and the lower traveling body can be recognized, and the second display information representing the person existing at a position indicated by the positional information.
